(19) United States
(12) Patent Application Publication
(10) Pub. No.: US 2017/0244540 A1
(43) Pub. Date: Aug. 24, 2017

(54) SIGNAL PROCESSING METHOD AND TRANSMISSION DEVICE

(71) Applicant: FUJITSU LIMITED, Kawasaki-shi (JP)

(72) Inventors: Ikue NAGASAWA, Kuki (JP); Satoshi TANAKA, Utsunomiya (JP)

(73) Assignee: FUJITSU LIMITED, Kawasaki-shi, (JP)

(21) Appl. No.: 15/419,114

(22) Filed: Jan. 30, 2017

(30) Foreign Application Priority Data
Feb. 24, 2016 (JP) 2016-033571

(51) Int. Cl. H04L 7/00

(52) U.S. Cl. CPC H04L 7/0075; H04L 7/0087

(57) ABSTRACT

A signal processing method executed by a transmission device, the signal processing method includes receiving a plurality of frame signals; extracting a plurality of synchronization signals each for performing frame synchronization and separating data of each of the plurality of frame signals, from the received plurality of frame signals; storing the data of each of the plurality of frame signals in a memory intermittently, using respective pulse widths of the plurality of synchronization signals as intervals, based on timing at which the plurality of synchronization signals are extracted; detecting timing at which data at a predetermined location in the frame signal is written to the memory, from the timing at which the plurality of synchronization signals are extracted; and reading data of each of the plurality of frame signals from the memory according to the detected timing.

### CROSS-REFERENCE TO RELATED APPLICATION

This application is based upon and claims the benefit of priority of the prior Japanese Patent Application 2016-033571, filed on Feb. 24, 2016, the entire contents of which are incorporated herein by reference.

### FIELD

The embodiments discussed herein are related to a signal processing method and a transmission device.

### BACKGROUND

A transmission device transmits a frame signal, for example, in accordance with a standard such as the optical transport network (OTN), the synchronous optical network (SONET), and synchronous digital hierarchy (SDH). When the transmission device receives a frame signal, the transmission device extracts a reception clock signal from the frame signal data received. There is phase dispersion in the reception clock signals according to through which transmission path the frame signal has been transmitted.

For this reason, when frame signals are received through plural transmission paths, the transmission device switches the clock signal for synchronizing with frame signals, from the extracted reception clock signal to an in-device clock signal, such that frame signals from each transmission path may be processed in synchronization with a common in-device clock signal (see, for example, Japanese Laid-open Patent Publication No. 5-260577). Such switching of clock signal is referred to, for example, as “clock transfer” or the like.

The transmission device, for example, performs a clock transfer by synchronizing the frame signal data with a reception clock signal for writing to a first-in first-out (FIFO), and then reading the data from the FIFO in synchronization with the in-device clock signal.

The reception clock signal phase fluctuates, for example, as the state of the transmission path changes. The in-device clock signal phase fluctuates, for example, as a clock is switched between active and standby systems in a redundant system. At this time, the reception clock signal cycle and the in-device clock signal cycle fluctuate temporarily.

Thus, when a clock fluctuation occurs repeatedly, a difference occurs between the writing speed to the FIFO and the reading speed from the FIFO in a clock transfer. As a result, an abnormality occurs in a relationship between a write address and a read address in the FIFO. For example, when the in-device clock signal cycle becomes shorter than the reception clock signal cycle, the FIFO reading speed exceeds the FIFO writing speed. Writing to the write address is accordingly caught up by reading from the read address, causing a shift in a phase difference between the write address and the read address. This thereby restricts data to be read from the FIFO in a normal manner.

In contrast, for example, when a phase difference between the write address and the read address is monitored, and as a result, in case in which an abnormality is detected, the phase difference between the write address and the read address may be temporarily returned to a normal state by resetting the read address to a predetermined value.

However, in this case, since the read address is reset to the predetermined value while data is read from the FIFO, a signal error occurs due to the data that has been read halfway through is discarded. The signal error may be avoided by providing the FIFO storage capacity larger than the frame signal data amount. However, in this case, another issue arises in the increased device cost. In consideration of the above-described issues, it is desirable that signal errors due to clock fluctuation may be reduced.

### SUMMARY

According to an aspect of the invention, a signal processing method executed by a transmission device, the signal processing method includes receiving a plurality of frame signals; extracting a plurality of synchronization signals each for performing frame synchronization and separating data of each of the plurality of frame signals, from the received plurality of frame signals; storing the data of each of the plurality of frame signals in a memory intermittently, using respective pulse widths of the plurality of synchronization signals as intervals, based on timing at which the plurality of synchronization signals are extracted; detecting timing at which data at a predetermined location in the frame signal is written to the memory, from the timing at which the plurality of synchronization signals are extracted; and reading data of each of the plurality of frame signals from the memory according to the detected timing.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a configuration diagram illustrating an example of a transmission system;

FIG. 2 is a configuration diagram illustrating an example of a network interface unit;

FIG. 3 is a configuration diagram illustrating a comparative example of a reception processing unit;

FIG. 4 is a time chart illustrating an example of an operation of the reception processing unit when the reception clock signal cycle is equal to the in-device clock signal cycle;

FIG. 5 is a time chart illustrating an example of an operation of the reception processing unit when the reception clock signal cycle is longer than the in-device clock signal cycle;

FIG. 6 is a time chart illustrating an example of an operation of the reception processing unit when the reception clock signal cycle is shorter than the in-device clock signal cycle;

FIG. 7 is a configuration diagram illustrating an embodiment of the reception processing unit.

FIG. 8A is a flowchart illustrating an example of an operation of a reception clock operation area of the reception processing unit;

FIG. 8B is a flowchart illustrating an example of an operation of an in-device clock operation area of the reception processing unit;

FIG. 9 is a time chart illustrating an example of an operation of the reception processing unit when the reception clock signal cycle is longer than the in-device clock signal cycle;

FIG. 10 is a time chart illustrating an example of an operation of the reception processing unit when the reception clock signal cycle is shorter than the in-device clock signal cycle;

FIG. 11 is a configuration diagram illustrating a reception processing unit according to another embodiment;

FIG. 12A is a first flowchart illustrating an example of a further operation of the in-device clock operation area of the reception processing unit;

FIG. 12B is a second flowchart illustrating an example of the further operation of the in-device clock operation area of the reception processing unit; and

FIG. 13 is a time chart illustrating an example of an operation of the reception processing unit.

### DESCRIPTION OF EMBODIMENTS

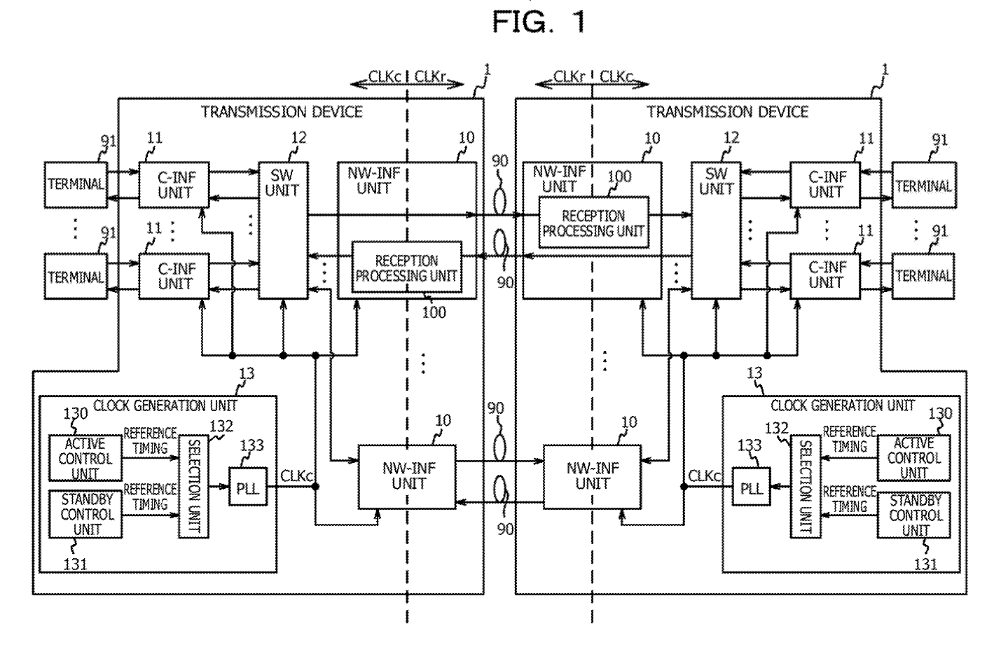

FIG. 1 is a configuration diagram illustrating an example of a transmission system. As an example, the transmission system includes a pair of transmission devices 1 and plural terminals 91 coupled to each of the transmission devices 1.

Two transmission devices 1 are coupled to each other, for example, through transmission paths 90 such as optical fibers of a relay network. In addition, each of the terminals 91 is coupled to the transmission device 1 through a transmission path such as an optical fiber of a user network. The transmission device 1 includes plural network interface units (hereinafter referred to as an “NW-INF unit”) 10, plural client interface units (hereinafter referred to as a “C-INF unit”) 11, a switch unit (hereinafter referred to as an “SW unit”) 12, and a clock generation unit 13.

Each of the NW-INF unit 10, the C-INF unit 11, the SW unit 12, and the clock generation unit 13 is, for example, an electronic circuit board on which an electronic component and the like are mounted, and is housed in a slot provided on the front face of a housing of the transmission device 1. The NW-INF unit 10, the C-INF unit 11, the SW unit 12, and the clock generation unit 13 are coupled to a wiring substrate provided on the back face of the transmission device 1 through connectors and the like, and perform communication through the wiring substrate.

The C-INF unit 11 is coupled to the terminal 91 and transmits and receives a client signal such as an Ethernet (registered trademark, hereinafter the same) frame to and from the terminal 91. The NW-INF unit 10 is coupled to a NW-INF unit 10 of the opposing transmission device 1 through the transmission path 90. The NW-INF unit 10 performs transmission and reception of an OTN frame signal that is an example of a frame signal.

The OTN frame signal includes, a frame alignment signal (FAS) which is located at the head of the signal and is a synchronization signal for performing frame synchronization, and plural tributary slots (TS) that store a client signal of the terminal 91. The OTN frame signal includes a forward error correction (FEC) area for correcting data errors. The OTN is defined in International Telecommunication Union Telecommunication Standardization Sector (ITU-T) recommendation G.709.

The SW unit 12 is coupled between the plural NW-INF units 10 and the plural C-INF units 11. The SW unit 12 exchanges a client signal between the NW-INF unit 10 and the C-INF unit 11, in accordance with route setting. Therefore, the client signal is input to the NW-INF unit 10 or the C-INF unit 11 according to the destination, through the SW unit 12.

The clock generation unit 13 generates an in-device clock signal CLKc and outputs the generated clock signal to the plural NW-INF units 10, the plural C-INF unit 11, and the SW unit 12. The clock generation unit 13 includes an active control unit 130, a standby control unit 131, a selection unit 132, and a phase locked loop (PLL) 133.

The active control unit 130 and the standby control unit 131 constitute a redundant system, and transmit reference timing signals of the in-device clock signals CLKc to the selection unit 132. The selection unit 132 outputs, in accordance with the switching setting, either one of the reference timing signals of the active control unit 130 or the reference timing signals of the standby control unit 131, to the PLL 133. The PLL 133 generates an in-device clock signal CLKc based on the reference timing signal that has been input from the selection unit 132.

The NW-INF unit 10 includes a reception processing unit 100 that executes reception processing of an OTN frame signal. The reception processing unit 100 performs a clock transfer between the reception clock signal CLKr extracted from the received OTN frame signal and the in-device clock signal CLKc. Therefore, in the reception processing unit 100, an area on the transmission path 90 side operates according to the reception clock signal CLKr, and an area on the SW unit 12 side operates according to the in-device clock signal CLKc.

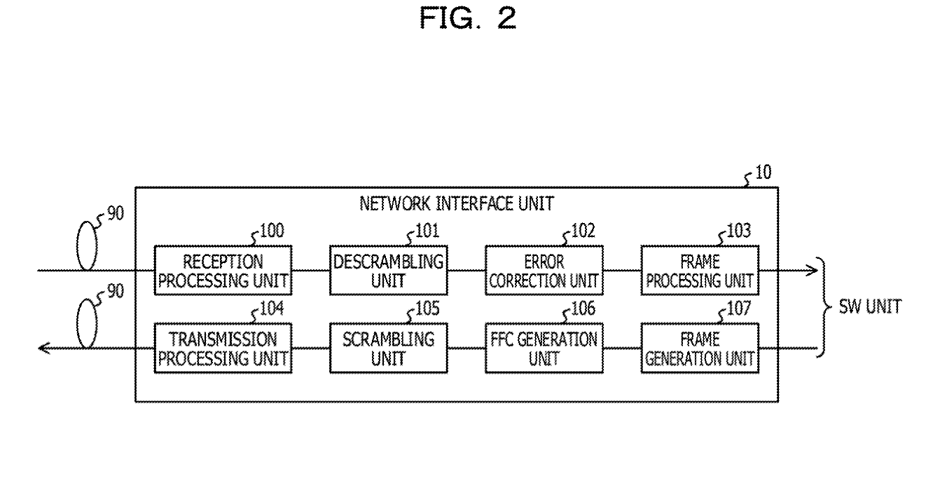

FIG. 2 is a configuration diagram illustrating an example of the NW-INF unit 10. The NW-INF unit 10 includes the reception processing unit 100, a descrambling unit 101, an error correction unit 102, a frame processing unit 103, a transmission processing unit 104, a scrambling unit 105, an FEC generation unit 106, and a frame generation unit 107.

The reception processing unit 100, the descrambling unit 101, the error correction unit 102, and the frame processing unit 103 are arranged in such order in a direction from the transmission path 90 toward the SW unit 12. The frame generation unit 107, the FEC generation unit 106, the scrambling unit 105, and the transmission processing unit 104 are arranged in such order in a direction from the SW unit 12 to the transmission path 90.

The reception processing unit 100 receives an OTN frame signal from the transmission path 90 and performs a clock transfer from the reception clock signal CLKr to the in-device clock signal CLKc. The descrambling unit 101 decodes the scrambling processing applied to the OTN frame signal. The error correction unit 102 corrects data errors based on the FEC area included in the OTN frame signal. The frame processing unit 103 extracts a client signal from the OTN frame signal, and output the extracted client signal to the SW unit 12.

A client signal is input from the SW unit 12 to the frame generation unit 107. The frame generation unit 107 generates an OTN frame signal by housing the client signal in the TS and multiplexing the client signal. The FEC generation unit 106 calculates a code for the FEC from the OTN frame signal data based on a predetermined calculation method, and inserts the code into the FEC area of the OTN frame signal. The scrambling unit 105 applies the scrambling processing to the OTN frame signal. The transmission processing unit 104 continuously transmits OTN frame signals to the transmission path 90 at a predetermined frame cycle.

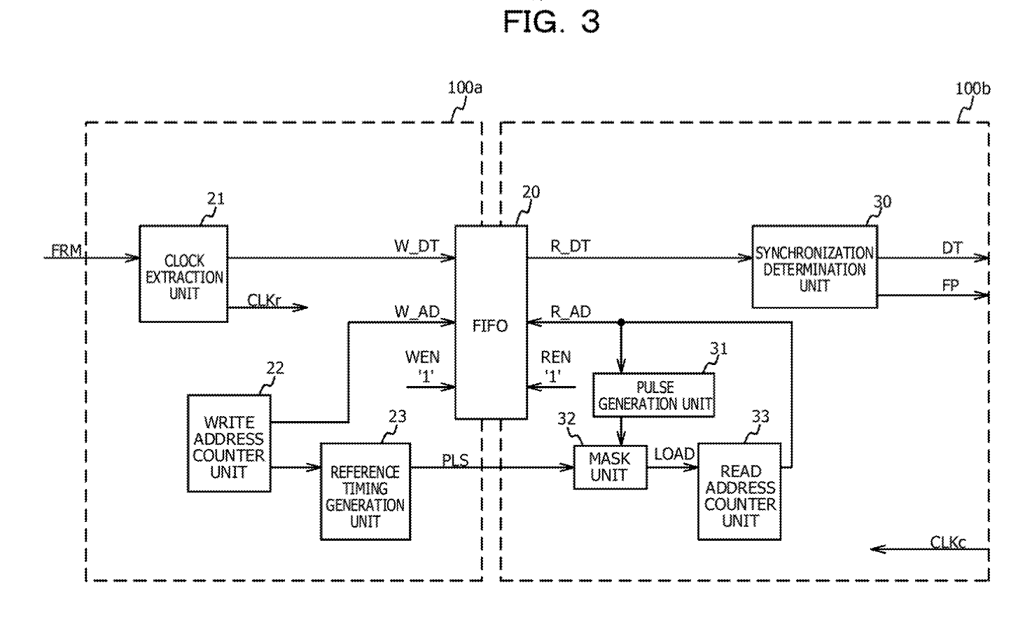

FIG. 3 is a configuration diagram illustrating a comparative example of a reception processing unit 100. In the reception processing unit 100 in this example, fluctuation in either the reception clock signal CLKr or the in-device clock signal CLKc generates a signal error.

The reception processing unit 100 includes a FIFO 20, a clock extraction unit 21, a write address counter unit 22, a reference timing generation unit 23, a synchronization determination unit 30, a pulse generation unit 31, a mask unit 32, and a read address counter unit 33. The reception processing unit 100 performs a clock transfer by first writing the received OTN frame signal FRM data to the FIFO 20 according to the reception clock signal CLKr, and then reading the data from the FIFO 20 according to the in-device clock signal CLKc.

Therefore, the reception processing unit 100 is divided, with FIFO 20 interposed therebetween, into a reception clock operation area 100a that operates in synchronization with the reception clock signal CLKr and an in-device clock operation area 100b that operates in synchronization with the in-device clock signal CLKc. The reception clock operation area 100a includes the clock extraction unit 21, the write address counter unit 22, and the reference timing generation unit 23. The in-device clock operation area 100b includes the synchronization determination unit 30, the pulse generation unit 31, the mask unit 32, and the read address counter unit 33.

An OTN frame signal FRM is input to the clock extraction unit 21. The clock extraction unit 21 is an example of a writing unit. The clock extraction unit 21 receives the OTN frame signal FRM, and writes the OTN frame signal FRM data to the FIFO 20. The clock extraction unit 21 extracts a reception clock signal CLKr from the OTN frame signal FRM, for example, using a serializer/deserializer (SerDes). Then, the clock extraction unit 21 distributes the reception clock signal CLKr to the write address counter unit 22 and the reference timing generation unit 23 in the reception clock operation area 100a.

The clock extraction unit 21 performs serial-parallel conversion of the OTN frame signal FRM data, and outputs the data as the write data W_DT for the FIFO 20. Here, the width of the write data W_DT equals to the width of a data bus for the FIFO 20. The write data W_DT is written to the FIFO 20 in synchronization with the reception clock signal CLKr. The clock extraction unit 21 is, for example, a SerDes device.

The write address counter unit 22 counts a write address W_AD in the FIFO 20, to which the write data W_DT is written in synchronization with the reception clock signal CLKr. The write address counter unit 22, for example, performs an iterative counting of 0, 1, 2, . . . , and N (N: positive integer), as the write address W_AD. The write address counter unit 22 outputs the write address W_AD to the FIFO 20 and the reference timing generation unit 23.

The reference timing generation unit 23 generates a timing pulse PLS that indicates reference timing for reading data from the FIFO 20, based on the write address W_AD. The generated timing pulse PLS is output to the mask unit 32.

More specifically, the reference timing generation unit 23 generates the timing pulse PLS when the write address W_AD reaches a value corresponding to half the capacity of the FIFO 20. Therefore, the timing pulse PLS is output when the amount of data written to the FIFO 20 reaches half the capacity of the FIFO 20.

A write enable signal WEN for the FIFO 20 indicates a valid area (‘1’: valid and ‘0’: invalid) of the write data W_DT to be input to the FIFO 20. Therefore, the write data W_DT is not written to the FIFO 20 while the write enable signal WEN=‘0’, but the write data W_DT is written to the FIFO 20 while the write enable signal WEN=‘1’. In this example, the write enable signal WEN is invariably fixed at ‘1’.

Read data R_DT, which is read from the FIFO 20, is input to the synchronization determination unit 30. The synchronization determination unit 30 performs synchronization determination of the OTN frame signal FRM, based on the read data R_DT. More specifically, the synchronization determination unit 30 detects a FAS of a synchronization signal from the read data R_DT. The synchronization determination unit 30 outputs the read data R_DT as frame data DT. Then, the synchronization determination unit 30 generates and outputs a frame pulse FP indicating the head of the frame, based on the detection timing of the FAS.

The read address counter unit 33 counts a read address R_AD in the FIFO 20, from which the read data R_DT is read in synchronization with the in-device clock signal CLKc. The read address counter unit 33, for example, performs an iterative counting of 0, 1, 2, . . . , and M (M: positive integer), as the read address R_AD. The read address counter unit 33 outputs the read address R_AD to the FIFO 20 and the pulse generation unit 31.

A read enable signal REN for the FIFO 20 indicates a valid area (‘1’: valid or ‘0’: invalid) of the read data R_DT to be output from the FIFO 20. Therefore, the read data R_DT is not read from the FIFO 20 while the read enable signal REN=‘0’, but the read data R_DT is read from the FIFO 20 while the read enable signal REN=‘1’. In this example, the read enable signal REN is invariably fixed at ‘1’.

The pulse generation unit 31 generates a window pulse indicating a range in which a clock transfer may be performed without a signal error, based on the read address R_AD. More specifically, the pulse generation unit 31 generates a window pulse when the read address R_AD is in a predetermined range. The pulse generation unit 31 outputs the window pulse to the mask unit 32.

The mask unit 32 masks the timing pulse PLS of the reference timing by the window pulse. More specifically, when the timing pulse is in the range of the window pulse, the mask unit 32 masks the timing pulse PLS and does not output the timing pulse PLS to the read address counter unit 33.

When the timing pulse is outside the range of the window pulse, the mask unit 32 outputs the timing pulse PLS to the read address counter unit 33 without masking the timing pulse PLS. The read address counter unit 33 loads the read address R_AD to 0 when the timing pulse PLS is input to the read address counter unit 33. Namely, the read address R_AD is reset to 0 by the timing pulse PLS. As a result, a phase difference between the write address W_AD and the read address R_AD is normalized.

When there is no clock fluctuation, namely, when the cycle of a reception clock signal CLKr is equal to the cycle of an in-device clock signal CLKc, the reception processing unit 100 in this example is capable of performing a clock transfer without occurrence of a signal error.

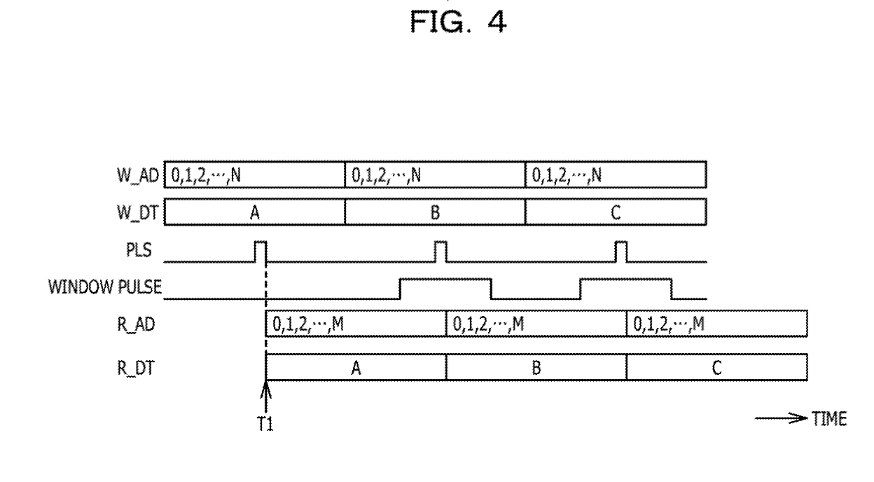

FIG. 4 is a time chart illustrating an example of an operation of the reception processing unit 100 when the cycle of a reception clock signal CLKr is equal to the cycle of an in-device clock signal CLKc. In this example, a clock transfer operation of three OTN frame signals FRM is described. Data of each of the OTN frame signals has a fixed length, and is respectively referred to as “A”, “B”, and “C”.

Each time an OTN frame signal FRM is input, a counting from 0 to N is performed for the write address W_AD by the write address counter unit 22. Each of the OTN frame signal FRM data “A”, “B”, and “C” is written from the clock extraction unit 21 to the FIFO 20 as the write data W_DT in sequence. The clock extraction unit 21 invariably writes the write data W_DT to the FIFO 20 because the write enable signal WEN is ‘1’ invariably.

A timing pulse PLS is generated for each of the OTN frame signals FRM when an amount of the write data W_DT that have been written to the FIFO 20 reaches half of the capacity of the FIFO 20. The timing pulse PLS is output at a position each corresponding to about the half of write data W_DT “A” “B”, and “C”.

The timing pulse PLS is invariably output at a predetermined position relative to the window pulse since there is no clock fluctuation. For this reason, the timing pulse PLS is not output to the read address counter unit 33, since the timing pulse PLS is masked by the mask unit 32.

The timing pulse PLS is output only at the time of input of the first frame signal FRM, in order to match the timing of the write address W_AD of the write address counter unit 22 and the timing of the read address R_AD of the read address counter unit 33. Therefore, the read address counter unit 33 starts counting the read address R_AD from the input timing T1 of the first timing pulse PLS.

Each time an OTN frame signal FRM is input, a counting from 0 to M is performed for the read address R_AD by the read address counter unit 33. Each of the OTN frame signals FRM data “A”, “B”, and “C” is read from data R_DT in sequence.

The reception clock signal CLKr phase fluctuates, for example, as the state of the transmission path 90 changes. Phase of the in-device clock signal CLKc fluctuates, for example, with a switching between the active control unit 130 and the standby control unit 131. At this time, the reception clock signal CLKr cycle and the in-device clock signal CLKc cycle temporarily fluctuate.

Thus, when clock fluctuation occurs repeatedly, a difference between a writing speed to the FIFO 20 and a reading speed from the FIFO 20 occurs in the clock transfer. Therefore, an abnormality occurs in a relationship between the write address W_AD and the read address R_AD in the FIFO. Namely, a shift occurs in the phase difference between the write address W_AD and the read address R_AD.

Therefore, the timing pulse PLS becomes outside the range of the window pulse, and is input to the read address counter unit 33. The read address R_AD is accordingly reset to 0 halfway through reading data, causing a signal error to occur.

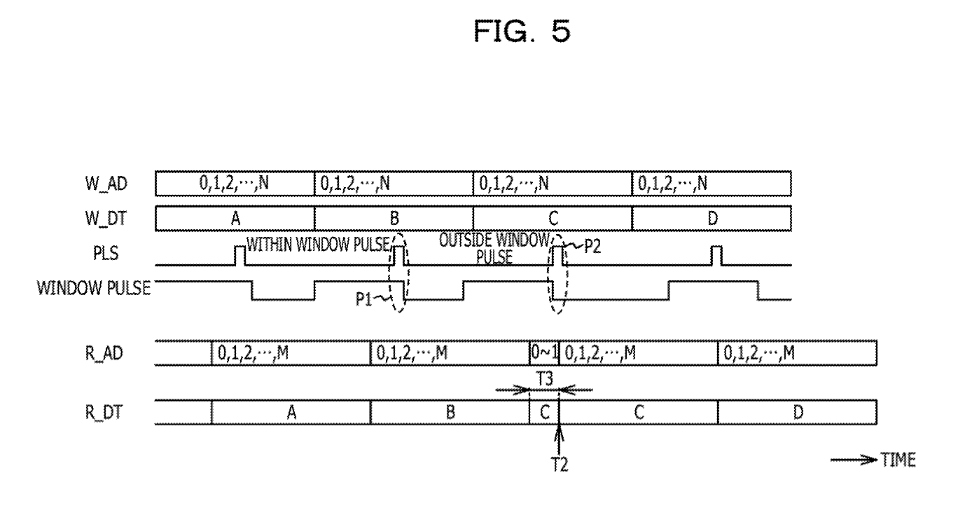

FIG. 5 is a time chart illustrating an example of an operation of the reception processing unit 100 when the cycle of a reception clock signal CLKr is longer than the cycle of an in-device clock signal CLKc. As understood by comparison with FIG. 4, in this example, the frequency of the in-device clock signal CLKc is higher than the frequency of the reception clock signal CLKr. Therefore, the window pulse is shifted in a direction of the earlier time than in the example of FIG. 4 (in the left direction on paper).

Thus, the timing pulse PLS is located in the vicinity of the end of the window pulse. For example, as illustrated by the symbol P1, the second timing pulse PLS is located within the range of the window pulse (see “within window pulse”). However, as illustrated by the symbol P2, the third timing pulse PLS is located outside the range of the window pulse (see “outside window pulse”).

Therefore, the read address counter unit 33 loads (resets) the read address R_AD to 0, due to the third timing pulse PLS being input after the read address counter unit 33 has counted the read address R_AD from 0 to I (<M). Thus, the read address counter unit 33 starts to count the read address R_AD newly from the input timing T2 of the third timing pulse PLS.

As a result, data “C” in the time range T3, which has been read halfway through from the FIFO 20, is discarded, and a signal error is detected. Then, reading of the data “C” newly starts from the timing T2.

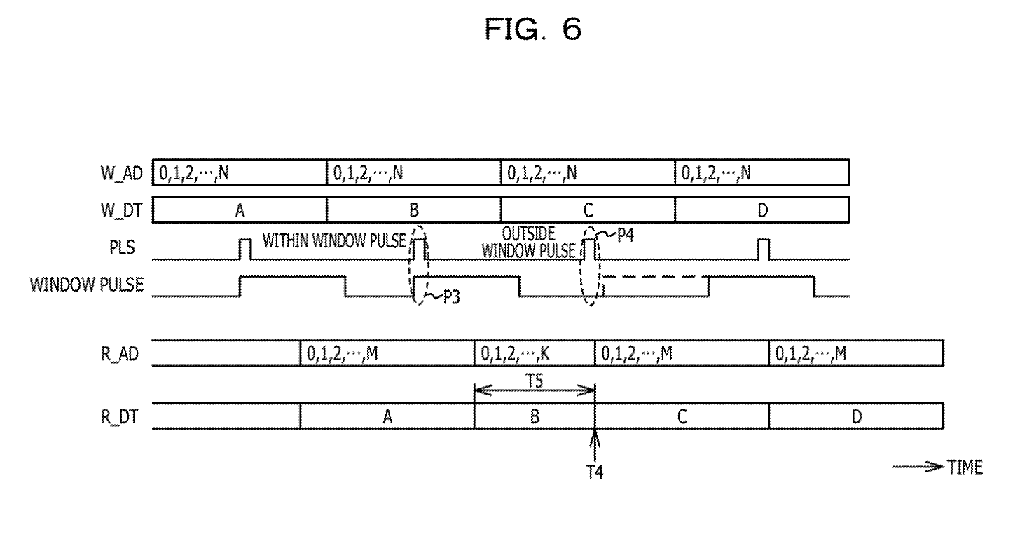

FIG. 6 is a time chart illustrating an example of an operation of the reception processing unit 100 when the cycle of a reception clock signal CLKr is shorter than the cycle of an in-device clock signal CLKc. As understood by comparison with FIG. 4, in this example, the frequency of the in-device clock signal CLKc is lower than the frequency of the reception clock signal CLKr. Therefore, the window pulse is shifted in a direction of the later time than in the example of FIG. 4 (in the right direction on paper).

Therefore, the timing pulse PLS is located in the vicinity of the head of the window pulse. For example, as illustrated by the symbol P3, the second timing pulse PLS is located within the range of the window pulse (see “within window pulse”). However, as illustrated by the symbol P4, the third timing pulse PLS is located outside the range of the window pulse (see the dotted line) (see “outside window pulse”).

Therefore, the read address counter unit 33 resets the read address R_AD to 0, due to the third timing pulse PLS being input after the read address counter unit 33 has counted the read address R_AD from 0 to K (<M). Thus, the read address counter unit 33 newly starts to count the read address R_AD from the input timing T4 of the third timing pulse PLS.

As a result, data “B” in the time range T5, which has been read halfway through from the FIFO 20 is discarded, and a signal error is detected. Then, reading of data “C” newly starts from the timing T4. Generation of a window pulse stops due to the read address R_AD being reset (see the dotted line).

In this manner, when the read address R_AD is reset to 0 partway through during the reading of data from the FIFO 20, the data that has been read partway through is discarded, causing a signal error to occur. This may be avoided by providing the storage capacity of the FIFO 20 larger than the data amount of the OTN frame signal FRM, but in this case, the device cost increases.

Thus, the transmission device 1 according to an embodiment detects a FAS that is a synchronization signal of an OTN frame signal FRM, and writes data other than the FAS to the FIFO after an interval equivalent to a FAS, based on the detection timing. Then, the transmission device 1 detects the timing at which data at a predetermined location in the OTN frame signal FRM other than the FAS is written to the FIFO, from the detection timing of the FAS, and starts to read the data from the FIFO based on the detection timing.

This thereby creates, for each of the OTN frame signals FRM, a time interval between the sets of read data R_DT, and the read address R_AD is reset in the time interval. A shift in the phase difference between the write address W_AD and the read address R_AD due to clock fluctuation is then absorbed.

Thus, unlike the above-described comparative example, the phase difference between the write address W_AD and the read address R_AD is reset for each of the OTN frame signals FRM. Moreover, the time interval between sets of read data R_DT suppresses the read address R_AD to be reset halfway through during the read data R_DT is read from the FIFO, thereby reducing signal errors due to clock fluctuation.

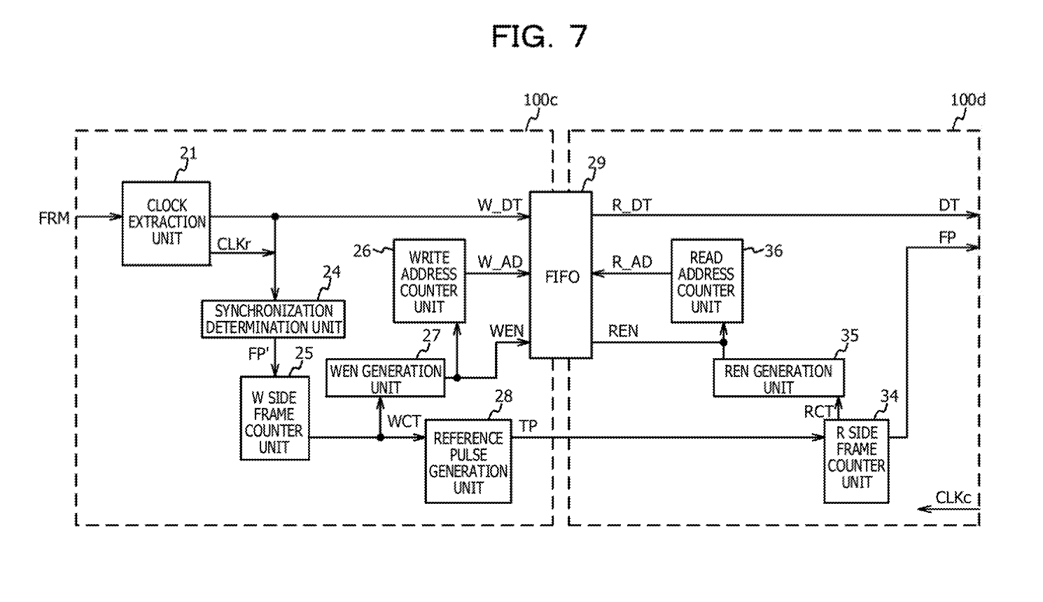

FIG. 7 is a configuration diagram illustrating a reception processing unit 100 according to the embodiment. In FIG. 7, the same symbol is assigned to a configuration common to that of FIG. 3, and the description thereof is omitted.

The reception processing unit 100 includes a clock extraction unit 21, a synchronization determination unit 24, a write side (W side) frame counter unit 25, a write address counter unit 26, a write enable signal (WEN) generation unit 27, a reference pulse generation unit 28, and a FIFO 29. The reception processing unit 100 also includes a read side (R side) frame counter unit 34, a read enable signal (REN) generation unit 35, and a read address counter unit 36.

The reception processing unit 100 performs a clock transfer by first writing data of a received OTN frame signal FRM to the FIFO 29 according to a reception clock signal CLKr, and reading the data from the FIFO 29 according to the in-device clock signal CLKc. For this reason, the reception processing unit 100 is divided, with the FIFO 29 interposed therebetween, into a reception clock operation area 100c that operates in synchronization with the reception clock signal CLKr, and an in-device clock operation area 100d that operates in synchronization with the in-device clock signal CLKc.

The reception clock operation area 100c includes the clock extraction unit 21, the synchronization determination unit 24, the W side frame counter unit 25, the write address counter unit 26, the WEN generation unit 27, and the reference pulse generation unit 28. The in-device clock operation area 100d includes the R side frame counter unit 34, the REN generation unit 35, and the read address counter unit 36.

Write data W_DT that has been output from the clock extraction unit 21 is input to the synchronization determination unit 24. The synchronization determination unit 24 is an example of a detection unit. The synchronization determination unit 24 detects a FAS of a synchronization signal from the OTN frame signal FRM received by the clock extraction unit 21. Namely, the synchronization determination unit 24 performs synchronization determination of the OTN frame signal FRM, and generates a frame pulse FP′ that indicates the head of the OTN frame signal FRM. The frame pulse FP′ is output to the W side frame counter unit 25.

The W side frame counter unit 25 starts counting by the write side frame counter WCT when the frame pulse FP′ is input to the W side frame counter unit 25. The write side frame counter WCT indicates a location in the OTN frame signal FRM of the write data W_DT to be written to the FIFO 29.

The W side frame counter unit 25 performs an iterative counting of the write side frame counter WCT from 0 to X (X: positive integer) in synchronization with the reception clock signal CLKr. Out of the OTN frame signal FRM data, data in a range of write side frame counter WCT=0 to Xh-1 (Xh<X) corresponds to the FAS.

The WEN generation unit 27 generates a write enable signal WEN based on the write side frame counter WCT, and outputs the generated signal to the write address counter unit 26 and the FIFO 29. The WEN generation unit 27 is an example of a write control unit. The WEN generation unit 27 controls the write data W_DT based on the timing at which the synchronization determination unit 24 has detected the FAS, such that data of the OTN frame signal FRM other than the FAS is written to the FIFO 29 after an interval equivalent to a FAS, for each of the OTN frame signals FRM.

The WEN generation unit 27 controls the write enable signal WEN at ‘0’ when the write side frame counter WCT is in the range of 0 to Xh-1. Accordingly, the FAS data corresponding to the above-described range is not written to the FIFO 29, out of the write data W_DT output from the clock extraction unit 21 to the FIFO 29.

The WEN generation unit 27 controls the write enable signal WEN at ‘1’ when the write side frame counter WCT is in the range of Xh to X. Accordingly, out of the data that W_DT outputs from the clock extraction unit 21 to the FIFO 29, the data corresponding to the above-described range, namely, the data other than the FAS (hereinafter referred to as “valid data”) is written to the FIFO 29. The FIFO 29 is an example of a storage unit that stores data.

The write address counter unit 26 performs an iterative counting of the write address W_AD from 0 to n (positive integer), based on the write enable signal WEN, in synchronization with the reception clock signal CLKr. When the write enable signal WEN is ‘0’, the write address counter unit 26 does not perform counting of the write address W_AD. When the write enable signal WEN is ‘1’, the write address counter unit 26 performs the counting of the write address W_AD. The write address W_AD is output to the FIFO 29.

The reference pulse generation unit 28 generates a timing pulse TP for notifying the timing at which reading of data from the FIFO 29 starts. The generated timing pulse TP is output to the R side frame counter unit 34. Due to the output of the timing pulse TP, the read address R_AD is reset.

The reference pulse generation unit 28 is an example of a read control unit. The reference pulse generation unit 28 detects the timing at which data at a predetermined position of the OTN frame signal FRM other than the FAS is written to the FIFO 29, from the timing at which the synchronization determination unit 24 detected the FAS. The reference pulse generation unit 28 controls timing at which reading of data from the FIFO 29 starts by generating a timing pulse TP, based on the detection timing.

As described above, for each of the OTN frame signals FRM, valid data is written to the FIFO 29 at a time interval equivalent to a FAS. A time interval accordingly occurs between read data R_DT for each of the OTN frame signals FRM. Namely, reading of data from the FIFO 29 is performed at a time interval for each of the OTN frame signals FRM. This thereby suppresses the read address R_AD to be reset, halfway through during the read data R_DT is read from the FIFO 29.

A shift of the phase difference between the write address W_AD and the read address R_AD due to clock fluctuation is absorbed by the time intervals between the sets of read data R_DT. Signal errors due to clock fluctuation are thereby reduced.

More specifically, the reference pulse generation unit 28 generates a timing pulse TP when the write side frame counter WCT is a specific value Xc (Xh<Xc<X). Here, out of the OTN frame signal FRM data, an amount of data that corresponds to Xh to Xc in the write side frame counter WCT is equal to half of the storage capacity of the FIFO 29. Namely, the reference pulse generation unit 28 detects timing at which the data amount of the OTN frame signals FRM written to the FIFO 29 reaches half of the storage capacity of the FIFO 29.

Therefore, reading of data from the FIFO 29 starts at the timing at which the data amounting to half its storage capacity has been written to the FIFO 29. Thus, at the start of reading, the respective locations of the read address R_AD and the write address W_AD in the address space of the FIFO 29 may be separated most distantly from each other, such that occurrences of a signal error due to clock fluctuation is reduced. The reference pulse generation unit 28, however, is not limited thereto, and may detect a timing at which a data amount of the OTN frame signals FRM written to the FIFO 29 reaches another predetermined amount of the storage capacity of the FIFO 29. In this case, too, the respective locations of the read address R_AD and the write address W_AD in the address space of the FIFO 29 may be separated from each other at the start of the reading.

When the timing pulse TP is input to the R side frame counter unit 34, the R side frame counter unit 34 starts counting of a read side frame counter RCT. The read side frame counter RCT indicates a location of the read data R_DT read from the FIFO 29, namely, the valid data, in the OTN frame signal FRM.

The R side frame counter unit 34 performs an iterative counting of the read side frame counter RCT from 0 to Y (Y: positive integer), in synchronization with the in-device clock signal CLKc. When the read side frame counter RCT is 0, the R side frame counter unit 34 outputs a frame pulse FP that indicates the head of the valid data, out of data of the OTN frame signal FRM. The read side frame counter RCT is output to the REN generation unit 35.

The REN generation unit 35 generates a read enable signal REN, based on the read side frame counter RCT, and outputs the signal to the FIFO 29 and the read address counter unit 36. The REN generation unit 35 determines whether or not the read data R_DT from the FIFO 29 is in a range of the valid data, based on the read side frame counter RCT.

The REN generation unit 35 determines, for example, the read data R_DT from the timing at which the read side frame counter RCT turned to 0 until the timing at which the read side frame counter RCT turned to Y to be a valid data range. When the read data R_DT is in the range of valid data, the REN generation unit 35 sets the read enable signal REN at ‘1’, and when the read data R_DT is not in the range of valid data, the REN generation unit 35 sets the read enable signal REN at ‘0’.

When the read enable signal REN is ‘1’, the read data R_DT is read from the FIFO 29. However, when the read enable signal REN is ‘0’, the read data R_DT is not read from the FIFO 29. Therefore, the data of the OTN frame signal FRM other than the FAS is read from the FIFO 29.

When the read enable signal REN is ‘1’, the read address counter unit 36 performs an iterative counting of the read address R_AD from 0 to m (m: positive integer) in synchronization with the in-device clock signal CLKc. The read address R_AD is output to the FIFO 29.

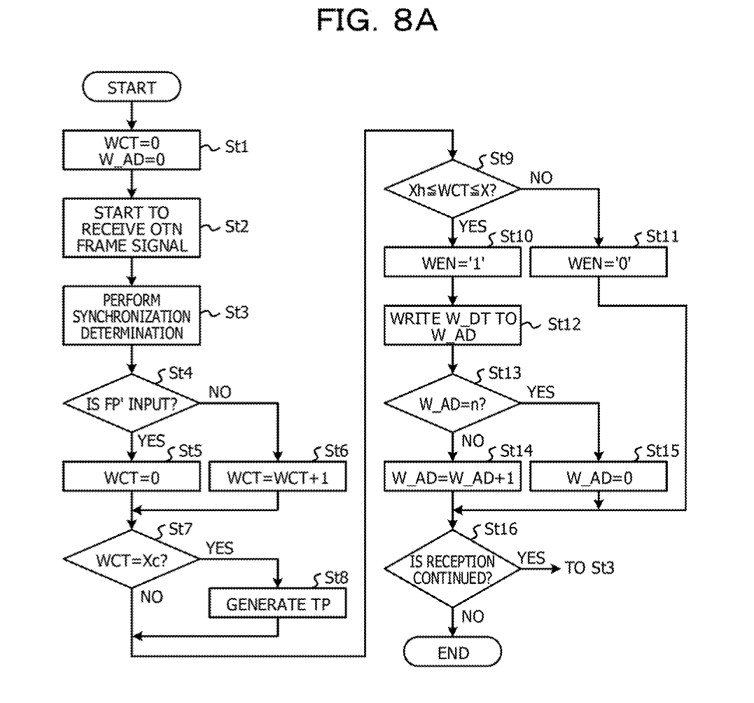

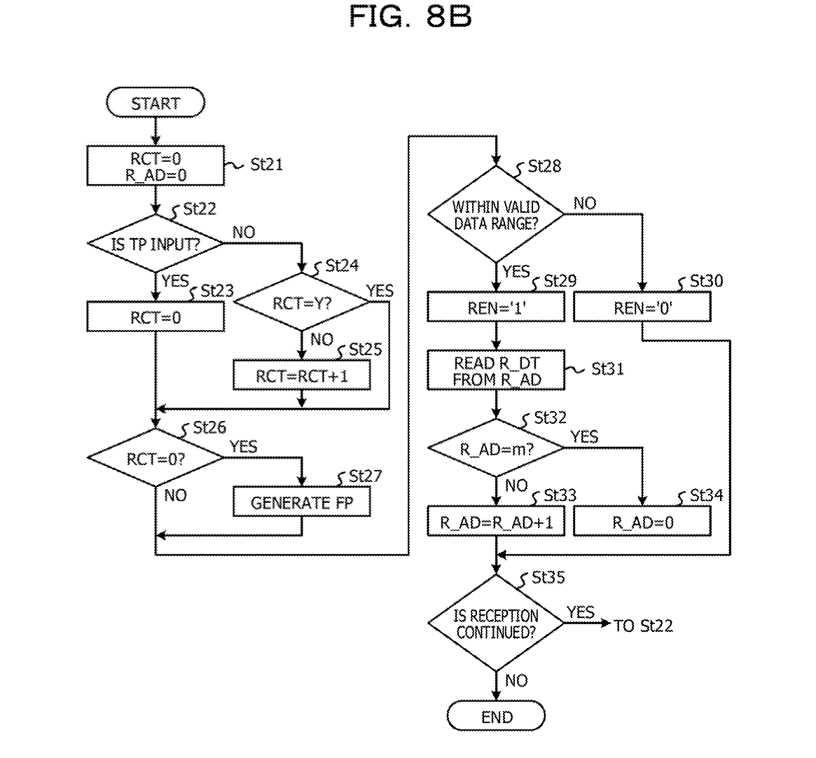

FIG. 8A is a flowchart illustrating an example of an operation of the reception clock operation area 100c of the reception processing unit 100. First, the write side frame counter WCT and the write address W_AD are initialized at 0 (St1). Next, the clock extraction unit 21 starts to receive an OTN frame signal FRM (St2).

Next, the synchronization determination unit 24 performs synchronization determination of the frame signal FRM (St3). Namely, the synchronization determination unit 24 detects a FAS from the received OTN frame signal FRM. When the synchronization determination unit 24 detects a FAS, the synchronization determination unit 24 outputs a frame pulse FP′.

Next, when the frame pulse FP′ is input to the W side frame counter unit 25 (Yes in St4), the W side frame counter unit 25 loads the write side frame counter WCT to 0 (St5). When the frame pulse FP′ is not input to the W side frame counter unit 25 (No in St4), the W side frame counter unit 25 adds “1” to the write side frame counter WCT (St6).

Next, when the write side frame counter WCT is a specific value Xc (Yes in St7), the reference pulse generation unit 28 generates a timing pulse TP (St8). When the write side frame counter WCT is not the specific value Xc (No in St7), the reference pulse generation unit 28 does not generate a timing pulse TP.

Next, the WEN generation unit 27 determines whether the write side frame counter WCT is in a range from Xh to X (St9). As a result, the WEN generation unit 27 determines whether or not the write data W_DT is data other than the FAS.

When 0≦WCT<Xh (No in St9), the WEN generation unit 27 sets the write enable signal WEN at ‘0’ (St11). Then, determination processing of St16 described later is executed.

When Xh≦WCT≦X (Yes in St9), the WEN generation unit 27 sets the write enable signal WEN at ‘1’ (St10). Next, the write data W_DT is written to the write address W_AD of the FIFO 29 (St12).

Next, the write address counter unit 26 determines whether or not the write address W_AD is n (St13). When the write address W_AD is n (Yes in St13), the write address counter unit 26 loads the write address W_AD to 0 (St15). When the write address W_AD is not n (No in St13), the write address counter unit 26 adds “1” to the write address W_AD (St14).

Next, when the reception of the OTN frame signal FRM is continued (Yes in St16), the processing of St3 is executed again, and when the reception of the OTN frame signal FRM is not continued (No in St16), the operation ends. The operation of the reception clock operation area 100c of the reception processing unit 100 is performed in this manner.

FIG. 8B is a flowchart illustrating an example of an operation of the in-device clock operation area 100d of the reception processing unit 100. First, the read side frame counter RCT and the read address R_AD are initialized at 0 (St21).

Next, the R side frame counter unit 34 determines whether or not an input of a timing pulse TP is present (St22). When there is an input of the timing pulse TP (Yes in St22), the R side frame counter unit 34 loads the read side frame counter RCT to 0 (St23).

When there is no input of the timing pulse TP (No in St22), the R side frame counter unit 34 determines whether or not the read side frame counter RCT is Y (St24). When the read side frame counter RCT is not Y (No in St24), the R side frame counter unit 34 adds “1” to the read side frame counter RCT (St25). When the read side frame counter RCT is Y (Yes in St24), the processing of St25 is not executed.

Next, the R side frame counter unit 34 determines whether or not the read side frame counter RCT is 0 (St26). When the read side frame counter RCT is 0 (Yes in St26), the R side frame counter unit 34 generates a frame pulse FP (St27). When the read side frame counter RCT is not 0 (No in St26), the R side frame counter unit 34 does not execute the processing of St27.

Next, the REN generation unit 35 determines whether or not the read data R_DT is in a range of valid data, based on the read side frame counter RCT (St28). When the read data R_DT is not in the range of the valid data (No in St28), the REN generation unit 35 sets the read enable signal REN at ‘0’ (St30). Then, determination processing of St35 described later is executed.

When the read data R_DT is in the range of the valid data (Yes in St28), the REN generation unit 35 sets the read enable signal REN at ‘1’ (St29). Next, the read data R_DT is read from the read address R_AD of the FIFO 29 (St31).

Next, the read address counter unit 36 determines whether or not the read address R_AD is m (St32). When the read address R_AD is m (Yes in St32), the read address counter unit 36 loads the read address R_AD to 0 (St34). When the read address R_AD is not m (No in St32), the read address counter unit 36 adds “1” to the read address R_AD (St33).

Next, when the reception of the OTN frame signal FRM is continued (Yes in St35), the processing of St22 is executed again, and when the reception of the OTN frame signal FRM is not continued (No in St35), the operation ends. As described above, the operation of the in-device clock operation area 100d of the reception processing unit 100 is performed.

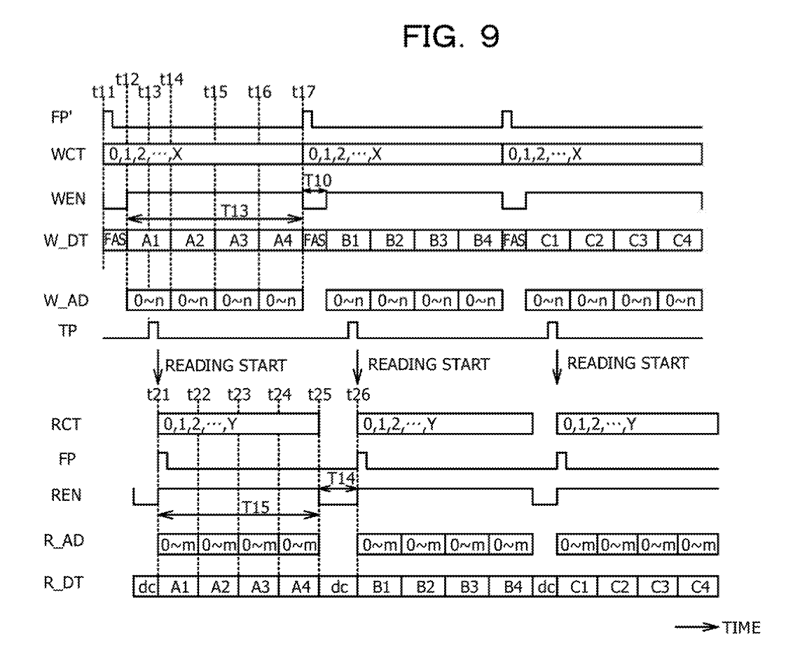

FIG. 9 is a time chart illustrating an example of an operation of the reception processing unit 100 when the cycle of a reception clock signal CLKr is longer than the cycle of an in-device clock signal CLKc. In this example, a case is described in which three OTN frame signals FRM are received, and clock fluctuation occurs in the first OTN frame signal FRM.

In this example, it is assumed that the storage capacity of the FIFO 29 is one fourth the valid data of the OTN frame signal FRM. Therefore, for a single OTN frame signal FRM, the write address counter unit 26 counts the write address W_AD from 0 to n four times. Then, the read address counter unit 36 counts the read address R_AD from 0 to m four times. The valid data of each of the OTN frame signals FRM is written to the FIFO 29 separated to four portions of “A1” to “A4”, “B1” to “B4”, and “C1” to “C4”.

At time t11, the first OTN frame signal FRM is received. The synchronization determination unit 24 detects a FAS and outputs the frame pulse FP′ each time the OTN frame signal FRM is received. The W side frame counter unit 25 sets the write side frame counter WCT at 0 and starts the counting each time the frame pulse FP′ is input to the W side frame counter unit 25. The OTN frame signals FRM are continuously received without time intervals. Therefore, the frame pulse FP′ is input to the W side frame counter unit 25 immediately after the write side frame counter WCT has reached X.

The WEN generation unit 27 detects a range of valid data from the write data W_DT, based on the write side frame counter WCT. When the write data W_DT is in the range of valid data of “A1” to “A4”, “B1” to “B4”, or “C1” to “C4”, the WEN generation unit 27 sets the write enable signal WEN at ‘1’ (High). When the write data W_DT is in the range of the FAS, the write enable signal WEN is set at ‘0’ (Low). Therefore, the data of the FAS is not written to the FIFO 29.

The WEN generation unit 27 sets the write enable signal WEN at ‘1’, for example, in a time period T13 of the data “A1” to “A4”. Then, in a FAS time period T10 which is followed by the respective data “A1” to “A4”, the write enable signal WEN is set at ‘0’. When the write enable signal WEN is ‘1’, the write address counter unit 26 performs an iterative counting of the write address W_AD from 0 to n.

Therefore, valid data “A1” to “A4”, “B1” to “B4”, and “C1” to “C4”, as the write data W_DT, are successively written to the FIFO 29, for each of the OTN frame signals FRM at a time interval equal to a FAS. For example, in the first OTN frame signal FRM, data “A1” is written during time t12 to time t14, data “A2” during time t14 to time t15, data “A3” during time t15 to time t16, and data “A4” during time t16 to time t17. The capacity of each piece of data “A1” to “A4”, “B1” to “B4”, or “C1” to “C4” is equal to the storage capacity of the FIFO 29.

Each time the write side frame counter WCT assumes the value Xc, the reference pulse generation unit 28 outputs a timing pulse TP. As described above, when an amount of the write data W_DT written to the FIFO 29 reaches half of the storage capacity of the FIFO 29, the reference pulse generation unit 28 outputs the timing pulse TP. In the case of the first OTN frame signal FRM, the timing pulse TP is output at time t13. Timing for reading data from the FIFO 29 is notified by the timing pulse TP.

Each time the timing pulse TP is input to the R side frame counter unit 34, the R side frame counter unit 34 loads the read side frame counter RCT to 0 and starts counting the valid data “A1” to “A4”, “B1” to “B4”, and “C1” to “C4”. In the case of the first OTN frame signal FRM, the R side frame counter unit 34 starts the counting from time t21. In the case of the second OTN frame signal FRM, the R side frame counter unit 34 starts the counting from time t26.

Each time the read side frame counter RCT assumes value 0, the R side frame counter unit 34 outputs a frame pulse FP. The frame pulse FP is used in the descrambling unit 101 and the like at the subsequent stages.

The REN generation unit 35 determines the range of data “A1” to “A4”, “B1” to “B4”, and “C1” to “C4”, in which the read data R_DT is valid, based on the read side frame counter RCT. Then, the REN generation unit 35 sets the read enable signal REN at ‘1’ within the range, and sets the read enable signal REN at ‘0’ outside the range. For example, the REN generation unit 35 sets the read enable signal REN at ‘1’ in time period T15 of the data “A1” to “A4”, and sets the read enable signal REN at ‘0’ in time period T14 corresponding to the FAS which is followed by the data “A1” to “A4”.

When the read enable signal REN is ‘1’, the read address counter unit 36 performs an iterative counting of the read address R_AD from 0 to m. Thus, the valid data “A1” to “A4”, “B1” to “B4”, and “C1” to “C4” are successively read as the read data R_DT from the FIFO 29.

For example, in the first OTN frame signal FRM, data “A1” is read during time t21 to time t22, and data “A2” is read during time t22 to time t23. Data “A3” is read during time t23 to time t24, and data “A4” is read during time t24 to time t25.

In time period T14 in which the read enable signal REN is ‘0’, the valid data is not read from the FIFO 29. Therefore, the read data R_DT assumes a value of “don't care” (see “dc”) in the data read processing. This time period T14 is a time interval between sets of read data R_DT for each of the above-described OTN frame signals FRM. The time period T14 is used for absorption of a shift of the phase difference between the write address W_AD and the read address R_AD due to clock fluctuation.

In this example, the frequency of the reception clock signal CLKr is lower than the frequency of the in-device clock signal CLKc. Therefore, for the first OTN frame signal FRM, the length of the time period T15 of the read enable signal REN (=‘1’) becomes shorter than that of the write enable signal WEN (=‘1’). Therefore, a shift occurs in the phase difference between the write address W_AD and the read address R_AD, and the time period T15 of the valid data “A1” to “A4” of the read data R_DT is also shorter than the time period T13 of the valid data “A1” to “A4” of the write data W_DT.

Accordingly, a timing margin from the writing of data “A1” to “A4” to the FIFO 29 to the reading of data “A1” to “A4” from the FIFO 29 is reduced. However, the shift of the phase difference between the write address W_AD and the read address R_AD is absorbed by an extension of the time period T14, in which the read data R_DT assumes the value of “don't care”. The phase difference between the write address W_AD and the read address R_AD is thereby adjusted to the normal value in the processing of the second and subsequent OTN frame signals FRM.

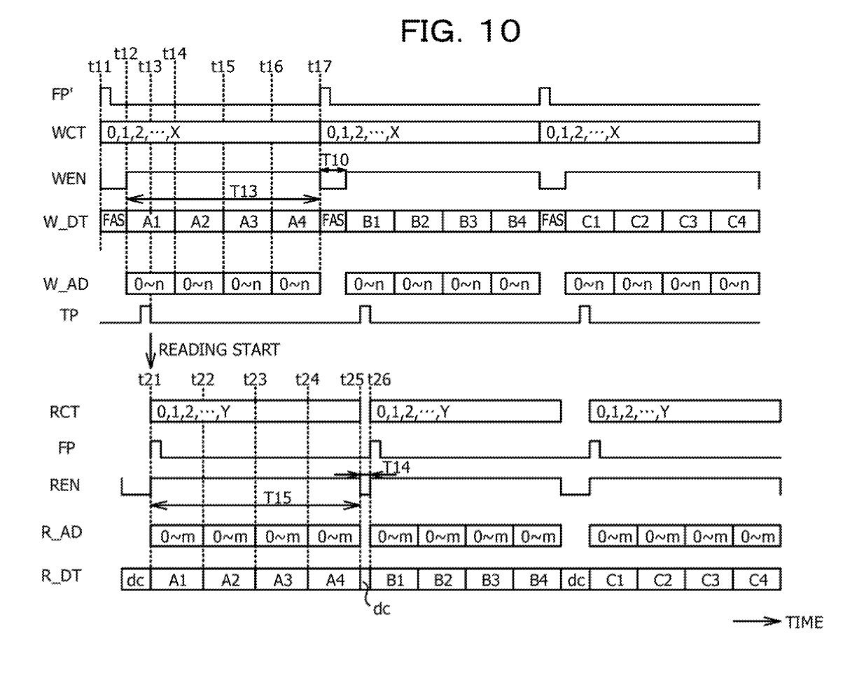

FIG. 10 is a time chart illustrating an example of an operation of the reception processing unit 100 when the cycle of a reception clock signal CLKr is shorter than the cycle of an in-device clock signal CLKc. In FIG. 10, the same symbol is assigned to a time period common to that of FIG. 9, and the description thereof is omitted.

In this example, the frequency of the reception clock signal CLKr is higher than the frequency of the in-device clock signal CLKc. Therefore, for the first OTN frame signal FRM, the length of the time period T15 of the read enable signal REN (=‘1’) becomes longer than that of the write enable signal WEN (=‘1’). Therefore, a shift occurs in the phase difference between the write address W_AD and the read address R_AD, and the time period T15 of the valid data “A1” to “A4” of the read data R_DT is also longer than the time period T13 of the valid data “A1” to “A4” of the write data W_DT.

Accordingly, a timing margin from the reading of data “A1” to “A4” from the FIFO 29 to the writing of the next piece of data “B1” to “B4” to the FIFO 29 is reduced. However, the shift of the phase difference between the write address W_AD and the read address R_AD is absorbed by a reduction of the time period T14, in which the read data R_DT assumes the value of “don't care”. The phase difference between the write address W_AD and the read address R_AD is thereby adjusted to a normal value in the processing of the second and subsequent OTN frame signals FRM.

In this manner, out of the OTN frame signals FRM data, only the valid data “A1” to “A4”, “B1” to “B4”, and “C1” to “C4” other than the FAS are written to the FIFO 29. The reading of data from the FIFO 29 starts at write timing of data at a predetermined position of the OTN frame signal FRM other than the FAS, based on the frame pulse FP.

Therefore, for each of the OTN frame signals FRM, the time period T14 (time interval) assuming a value of “don't care” occurs between the read data R_DT. Thus, this suppresses the read address R_AD to be reset halfway through during the reading of the read data R_DT from the FIFO 29. In addition, such a time period T14 is used for absorbing the shift of the phase difference between the write address W_AD and the read address R_AD due to clock fluctuation, thereby reducing signal errors.

However, when excessive clock fluctuation occurs, the shift of the phase difference between the write address W_AD and the read address R_AD exceeds an allowable range of the time period T14, and the timing pulse TP may be output during the reading of data from the FIFO 29.

Thus, as described in the following example, the reception processing unit 100 may monitor reading of data from the FIFO 29, and when the timing pulse TP is input during the data reading, may start reading of new data after completing reading the data.

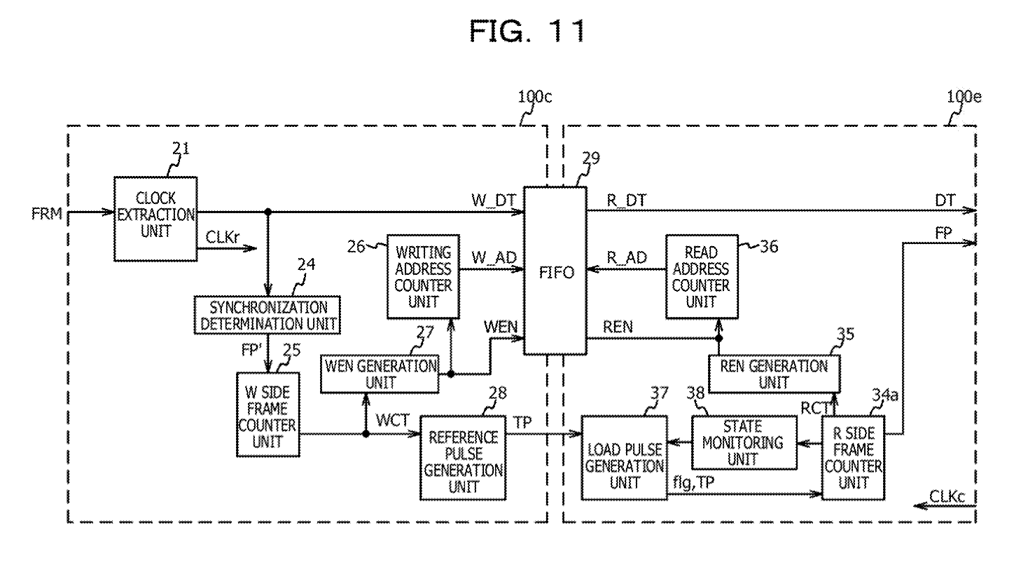

FIG. 11 is a configuration diagram illustrating a reception processing unit 100 in this example. In FIG. 11, the same symbol is assigned to a configuration common to that of FIG. 7, and the description thereof is omitted.

The reception processing unit 100 includes a clock extraction unit 21, a synchronization determination unit 24, a W side frame counter unit 25, a write address counter unit 26, a WEN generation unit 27, a reference pulse generation unit 28, and a FIFO 29. The reception processing unit 100 further includes an R side frame counter unit 34a, an REN generation unit 35, a read address counter unit 36, a load pulse generation unit 37, and a state monitoring unit 38.

A reception clock operation area 100c includes the clock extraction unit 21, the synchronization determination unit 24, the W side frame counter unit 25, the write address counter unit 26, the WEN generation unit 27, and the reference pulse generation unit 28. An in-device clock operation area 100e includes the R side frame counter unit 34a, the REN generation unit 35, the read address counter unit 36, the load pulse generation unit 37, and the state monitoring unit 38.

The state monitoring unit 38 is an example of a determination unit. The state monitoring unit 38 determines whether or not read data R_DT is being read from the FIFO 29. Namely, the state monitoring unit 38 monitors reading of data from the FIFO 29.

More specifically, the state monitoring unit 38 determines whether or not read data R_DT is being read from the FIFO 29, based on the read side frame counter RCT. However, the state monitoring unit 38, not limited thereto, may perform the determination based on a read enable signal REN. The state monitoring unit 38 outputs the determination result to the load pulse generation unit 37.

The load pulse generation unit 37 is an example of a correction unit. As a result of the determination by the state monitoring unit 38, in a case in which data is being read from the FIFO 29 and the timing to start reading has arrived, the load pulse generation unit 37 corrects the timing to start reading data to a timing after the completion of reading the data. More specifically, in a case in which the timing pulse TP is input from the reference pulse generation unit 28 during the data reading is performed, the load pulse generation unit 37 changes a flag flg from “L” (Low) to “H” (High) and outputs the information to the R side frame counter unit 34a. The load pulse generation unit 37 outputs the timing pulse TP to the R side frame counter unit 34a.

The R side frame counter unit 34a performs an iterative counting of the read side frame counter RCT from 0 to Y in synchronization with the in-device clock signal CLKc. The R side frame counter unit 34a performs a counter operation according to the flag flg. In a case in which the read side frame counter RCT is Y, and when flg=H, the R side frame counter unit 34a sets “flg=L” for the load pulse generation unit 37, and loads the read side frame counter RCT to 0.

Thus, even in a case in which the timing pulse TP is input during reading data from the FIFO 29, the R side frame counter unit 34a is capable of loading the read side frame counter RCT to 0 after the reading of the data is completed. Accordingly, reading of the data is not interrupted, and reading of new data is started after completing reading the data.

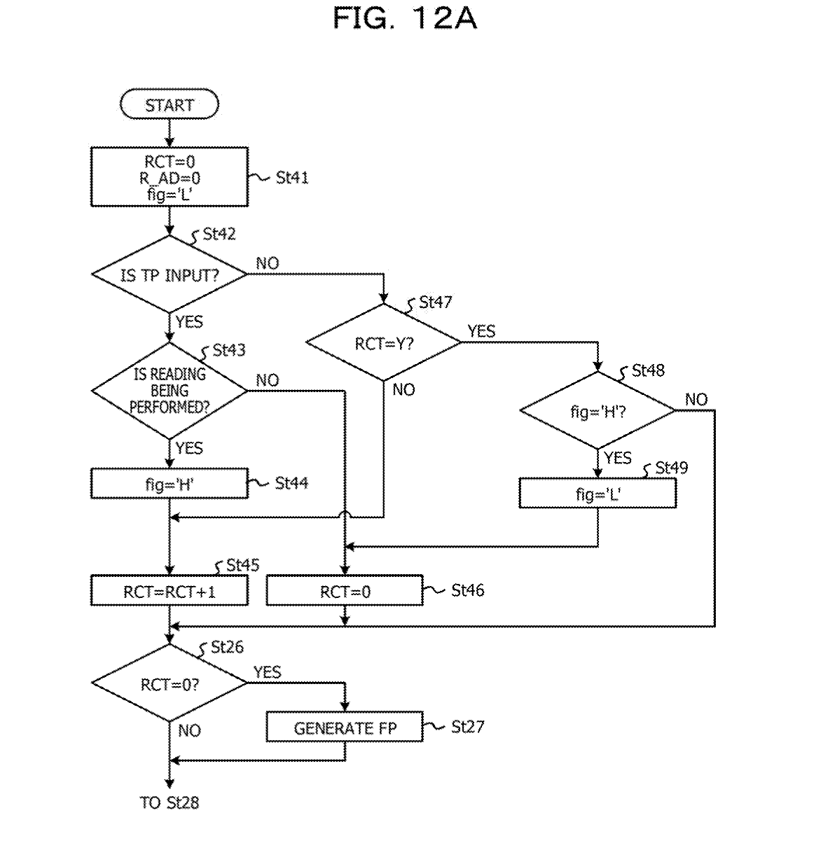

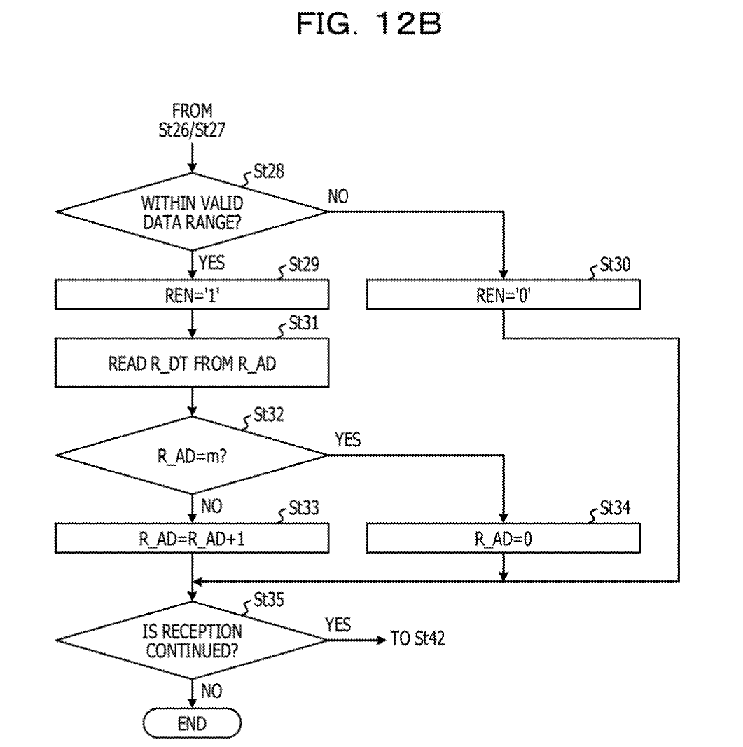

FIGS. 12A and 12B are flowcharts each illustrating an operation of the in-device clock operation area 100e of the reception processing unit 100 in this example. In FIGS. 12A and 12B, the same symbol is assigned to processing common to that of FIG. 8B, and the description thereof is omitted.

First, each of the read side frame counter RCT and the read address R_AD are initialized at 0, and the flag flg is initialized at “L” (St41). Next, the load pulse generation unit 37 determines whether or not an input of the timing pulse TP is present (St42).

When the timing pulse TP is input to the load pulse generation unit 37 (Yes in St42), the load pulse generation unit 37 determines whether or not data is being read from the FIFO 29, based on the determination result by the state monitoring unit 38 (St43). When data is being read (Yes in St43), the load pulse generation unit 37 sets “flag flg=H” (St44).

Next, the R side frame counter unit 34a adds “1” to the read side frame counter RCT (St45). At this time, since the R side frame counter unit 34a ignores the timing pulse TP, the read side frame counter RCT is not loaded to 0. Then, the processing in and following the above-described St26 is executed.

When data is not being read (No in St43), the R side frame counter unit 34a loads the read side frame counter RCT to 0, based on the timing pulse TP (St46). Then, the processing in and following the above-described St26 is executed.

When the timing pulse TP is not input (No in St42), the R side frame counter unit 34a determines whether or not the read side frame counter RCT is Y (St47). When the read side frame counter RCT is not Y (No in St47), the R side frame counter unit 34a adds “1” to the read side frame counter RCT (St45). Then, the processing in and following the above-described St26 is executed.

When the read side frame counter RCT is Y (Yes in St47), the R side frame counter unit 34a determines whether or not the flag flg is “H” (St48). When the flag flg is “L” (No in St48), the processing in and following the above-described St26 is executed.

When the flag flg is “H” (Yes in St48), the R side frame counter unit 34a controls the load pulse generation unit 37 such that the flag flg is set at “L” (St49). Next, the R side frame counter unit 34a loads the read side frame counter RCT to 0 (St46).

Since the loading of the read side frame counter RCT is thus extended until the completion of reading the data, timing to start reading new data is corrected to a timing after the reading of data is completed. Then, the processing in and following the above-described St26 is executed. The operation of the in-device clock operation area 100e of the reception processing unit 100 is performed in this manner.

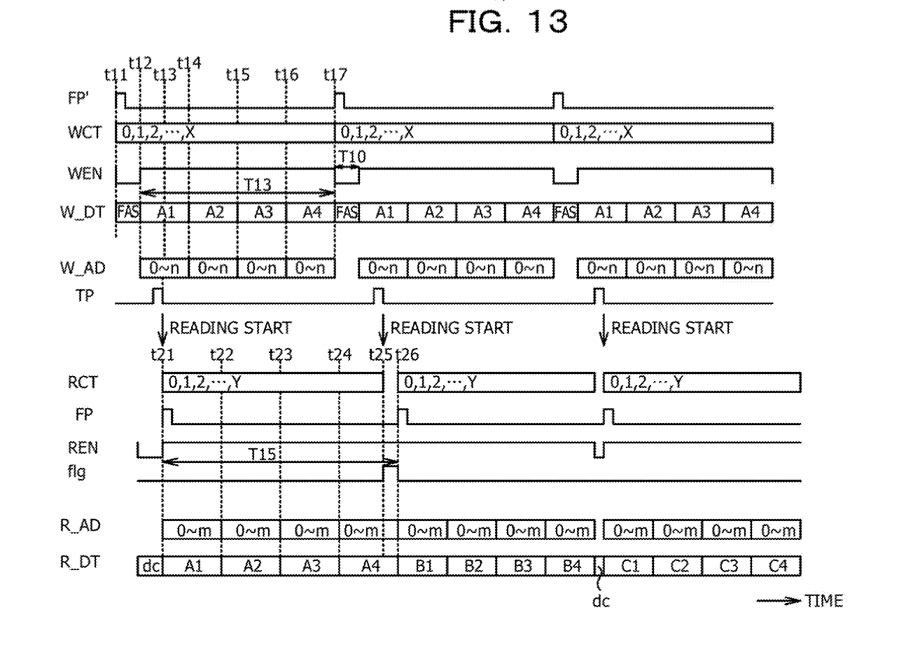

FIG. 13 is a time chart illustrating an operation of the reception processing unit 100 in this example. In FIG. 13, the same symbol is assigned to a time period common to that of FIG. 9, and the description thereof is omitted.

In this example, it is assumed that the cycle of a reception clock signal CLKr is shorter than the cycle of an in-device clock signal CLKc. Therefore, in processing of the first OTN frame signal FRM, a timing pulse TP is output at time t25 in a time period T15 in which data “A4” is read from the FIFO 29. Therefore, the flag flg is controlled at “H” at time t25.

Timing to start reading the next data “B1” is thus corrected to time t26, which is the time after completing reading data “A4”. Reading of data is thereby performed normally. The flag flg is then returned to “L”.

As described above, the transmission device 1 according to the embodiment includes the FIFO 29 that stores data, the clock extraction unit 21, the synchronization determination unit 24, the WEN generation unit 27, and the reference pulse generation unit 28. The clock extraction unit 21 receives an OTN frame signal FRM and writes the OTN frame signal FRM data to the FIFO 29.

The synchronization determination unit 24 detects a FAS for performing frame synchronization from the OTN frame signal FRM received by the clock extraction unit 21. The WEN generation unit 27 controls the write data W_DT such that the OTN frame signal FRM data other than the FAS is written to the FIFO 29 at a time interval equal to a FAS, for each of the OTN frame signals FRM, based on the timing at which the synchronization determination unit 24 has detected the FAS.

The reference pulse generation unit 28 detects timing at which data at a predetermined location in the OTN frame signal FRM other than the FAS is written to the FIFO 29, from the timing at which the synchronization determination unit 24 has detected the FAS. Then, the reference pulse generation unit 28 controls timing to start reading the read data R_DT from the FIFO 29, based on the detected timing.

In the above-described configuration, valid data is written to the FIFO 29 at the time interval equal to a FAS, for each of the OTN frame signals FRM. Therefore, for each of the OTN frame signals FRM, a time interval is generated between sets of read data R_DT. Namely, reading of data from the FIFO 29 is performed at a time interval for each of the OTN frame signals FRM. This thereby suppresses the read address R_AD to be reset halfway through during the reading of the read data R_DT from the FIFO 29.

A shift of the phase difference between the write address W_AD and the read address R_AD due to clock fluctuation is absorbed by the time interval between the sets of read data R_DT. Thus, a signal error due to clock fluctuation is reduced.

The signal processing method according to the embodiment includes the following steps.

Step (1): An OTN frame signal FRM is received.

Step (2): A FAS for performing frame synchronization is detected from the received OTN frame signal FRM.

Step (3): The OTN frame signal FRM data other than the FAS is written to the FIFO 29 at a time interval equal to a FAS, for each of the OTN frame signals FRM, based on timing at which the FAS has been detected.

Step (4): Timing at which data at a predetermined position of the OTN frame signal FRM is written to the FIFO 29 is detected from the timing at which the FAS has been detected.

Step (5): Timing at which reading of the data from the FIFO 29 starts is controlled based on the detected timing.

The signal processing method according to the embodiment includes a configuration similar to that of the above-described transmission device 1, and an operation effect similar to that of the above-described content is thereby obtained.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A signal processing method executed by a processor included in a transmission device, the signal processing method comprising:
receiving a plurality of frame signals;
extracting a plurality of synchronization signals each for performing frame synchronization and separating data of each of the plurality of frame signals, from the received plurality of frame signals;
storing the data of each of the plurality of frame signals in a memory intermittently, using respective pulse widths of the plurality of synchronization signals as intervals, based on timing at which the plurality of synchronization signals are extracted;
detecting timing at which data at a predetermined location in the frame signal is written to the memory, from the timing at which the plurality of synchronization signals are extracted; and
reading data of each of the plurality of frame signals from the memory according to the detected timing.

2. The signal processing method according to claim 1,
wherein the detecting includes detecting timing at which a data amount of the plurality of frame signals written to the memory reaches a predetermined amount of a storage capacity of the memory.

3. The signal processing method according to claim 2,
wherein the detecting includes detecting timing at which the data amount of the plurality of frame signals written to the memory reaches half of the storage capacity of the memory.

4. The signal processing method according to claim 1 further comprising:
determining whether or not the reading of data from the memory is in progress; and
when it is determined that the reading of the data is in progress, correcting the timing to start reading to the timing after the reading of the data from the memory is completed, when the timing to start reading arrives.

5. The signal processing method according to claim 1,
wherein each of the plurality of synchronization signals is located at the head of a corresponding frame signal out of the plurality of frame signals.

6. The signal processing method according to claim 1,
wherein the storing includes storing the data in the memory intermittently by performing masking such that the plurality of synchronization signals are not written to the memory using an enable signal turned on at time periods for the data and turned off at time periods for the plurality of synchronization signals.

7. The signal processing method according to claim 1,
wherein the reading includes reading the data according to a frame pulse generated based on the detected timing.

8. A transmission device comprising:
a memory; and
a processor coupled to the memory and configured to:
receive a plurality of frame signals,
extract a plurality of synchronization signals each for performing frame synchronization and separating data of each of the plurality of frame signals, from the received plurality of frame signals,
store the data of each of the plurality of frame signals in a memory intermittently, using respective pulse widths of the plurality of synchronization signals as intervals, based on timing at which the plurality of synchronization signals are extracted,
detect timing at which data at a predetermined location in the frame signal is written to the memory, from the timing at which the plurality of synchronization signals are extracted, and
read data of each of the plurality of frame signals from the memory according to the detected timing.

9. The transmission device according to claim 8,
wherein the processor is configured to detect timing at which a data amount of the plurality of frame signals written to the memory reaches a predetermined amount of a storage capacity of the memory.

10. The transmission device according to claim 9,
wherein the processor is configured to detect timing at which the data amount of the plurality of frame signals written to the memory reaches half of the storage capacity of the memory.

11. The transmission device according to claim 8, wherein the processor is configured to:
determine whether or not the reading of data from the memory is in progress, and
when it is determined that the reading of the data is in progress, correct the timing to start reading to the timing after the reading of the data from the memory is completed, when the timing to start reading arrives.

12. The transmission device according to claim 8,
wherein each of the plurality of synchronization signals is located at the head of a corresponding frame signal out of the plurality of frame signals.

13. The transmission device according to claim 8,
wherein the processor is configured to store the data in the memory intermittently by performing masking such that the plurality of synchronization signals are not written to the memory using an enable signal turned on at time periods for the data and turned off at time periods for the plurality of synchronization signals.

14. The transmission device according to claim 8,
wherein the processor is configured to read the data according to a frame pulse generated based on the detected timing.
